(19) United States
(12) Patent Application Publication
(10) Pub. No.: US 2026/0053158 A1
(43) Pub. Date: Feb. 26, 2026

(54) STABLE OLEOSOME PREPARATION FOR EDIBLE APPLICATIONS

(71) Applicant: ARCHER-DANIELS-MIDLAND COMPANY, Decatur, IL (US)

(72) Inventors: Wahyu Wijaya, Decatur, IL (US); Swapnil Jadhav, Bloomington, IL (US); Jason Li, Decatur, IL (US)

(21) Appl. No.: 19/100,722

(22) PCT Filed: Jul. 31, 2023
(86) PCT No.: PCT/US2023/071355

§ 371 Date: Feb. 3, 2025

Related U.S. Application Data
(60) Provisional application No. 63/395,292, filed on Aug. 4, 2022.

(51) Int. Cl. A23C 11/10; A23C 13/12; A23D 7/005; A23L 11/65; A23L 29/231; A23L 29/25; A23L 29/256

(52) U.S. Cl. CPC A23C 11/103; A23C 13/12; A23D 7/0053; A23L 11/65; A23L 29/231; A23L 29/25; A23L 29/256

(57) ABSTRACT

Improved acid- and high temperature-stable oleosome fractions from a plant source are described for edible applications as or in food products for human consumption, for example, in vegetable and nut milks and creamers, juices and soda beverages, coffee creamers, yogurt products, ice creams, smoothies and sherbets.

### FIELD OF THE INVENTION

Animal milk compositions vary somewhat depending on the species (e.g., cow, goat, sheep), breed (e.g, Holstein, Jersey), the animal's feed and the animal's stage of lactation. In general, however, all animal milk compositions are comprised of at least 80% water, 3-8% carbohydrates (mostly lactose), 2-5% fat, 2-4% protein, and less than 1% minerals (all by percent of the composition's total weight). Milk obtained from animals has a relatively short shelf life, is not desirable for vegan or vegetarian diets, and can cause problems with digestion for a subset of the human population that are lactose intolerant. One factor that gives animal milk its generally creamy texture and ability to blend with different food stuffs is the stable colloidal suspension of fat globules present in the primarily aqueous environment.

Milk substitutes derived from legumes, nuts and some grains have gained wide popularity amongst health-conscious consumers and lactose intolerant individuals Example milk substitutes include soy milk, coconut milk, almond milk, coconut milk. cashew milk, macadamia milk, oat milk, rice milk, quinoa milk, and even hemp milk. Milk substitutes derived from oily plants like soy and nuts are generally made by soaking and grinding the whole fruit in about 10 weight volumes of water for a given weight of soy or nuts, boiling the mixture, and filtering out particulates to yield plant milk. This plant milk contains natural oil droplets. The oil in seed plants, grains, nuts are already in the form of emulsified droplets in the milk substitutes prepared from them, which droplets are stabilized by phospholipid and a particular protein membrane. Such droplets are referred to as oleosomes and a fraction of plant material that contains such oleosomes is referred to as an oleosome fraction. All vegetable and nut derived, animal milk and cream substitutes contain an oleosome fraction.

The oleosomes formed in vegetable and nut milks and creams (hereinafter simply referred as ‘vegetable milks” for brevity) typically have a median diameter of less than 10 microns. Vegetable milks containing such oleosomes tend to separate from the emulsion when used as a creamer for hot beverages such as coffee, forming chunky particulate particles in the beverage that are organoleptically and visually unappealing. It is believed the formation of these chunky particles is the result of merger or agglomeration of smaller oleosomes into larger oleosome bodies in the hot liquid. There is a recognized need in the vegetable milk art for vegetable milks including oleosomes that resist agglomerating and/or separating from the beverage solution upon mixing with hot liquids and acidic pH, oleosomes that we will describe and denote hereafter as “stable oleosomes” or as a “stable oleosome fraction”.

### SUMMARY

Provided herein is a vegetable milk composition that contains an oleosome fraction and an anionic polysaccharide or polysaccharides in a sufficient proportion relative to the oleosome fraction whereby a vegetable milk having a stable oleosome fraction results. In typical embodiments, a ratio of the weight of the anionic polysaccharide(s) to the weight of oil in the composition is from 0.1:1 to 5:1. In more preferred embodiments the ratio is 0.5:1 to 2.0:1. In particularly exemplary embodiments the ratio is about 1:1.

In certain embodiments, propylene glycol alginate is used in the subject vegetable milk composition as an anionic polysaccharide. In other embodiments, other anionic polysaccharides such as pectin, gum arabic, sulfated carrageenan, sulfated chondroitin, xanthan gum, carboxymethyl cellulose and carboxy methyl starch or some combination of these may be used.

In certain embodiments, a soymilk or cream is provided containing an oleosome fraction and an anionic polysaccharide or polysaccharides. In other embodiments, a milk or cream made from oat, rice, almond, cashew, macadamia or coconut is provided having an oleosome fraction and an anionic polysaccharide or polysaccharides.

In certain embodiments of the inventive composition, the oleosomes therein have a median diameter of 0.25 to 0.75 microns.

In certain embodiments, when heated to a temperature of 85° C. for 30 minutes at a pH of 4.5, the median dimension of oleosomes in the inventive vegetable milk compositions remains within 20% of the median dimension of what they would be at a pH of 7.2.

In another aspect, there is provided a method of making the inventive vegetable milk compositions that includes mixing an anionic polysaccharide or polysaccharides with an oleosome fraction obtained from a vegetable or nut source to improve the heat and low pH stability of the oleosome fraction so supplied.

### BRIEF DESCRIPTION OF THE DRAWINGS

FIG. 1A. shows the median size of oleosomes in a standard soybean oleosome fraction (0.25 wt % with respect to oleosome dry weight) at different pH values from 7.2 to 4.5, and median diameter values for the oleosomes in the same fraction (D50) before and after heat treatment at 85° C. for 30 min. FIG. 1B shows the same data as FIG. 1A but on a different scale, showing only the size distribution differences between pH 7.2 and 5.0. FIG. 1C shows for comparison the median size of oleosomes in a soybean oleosome fraction (0.25 wt % with respect to oleosome dry weight) according to the present invention (containing alginate (0.67 wt %)) at different pH values from 7.2 to 4.5, and then D50 values before and after heat treatment at 85° C. for 30 min.

FIG. 2A shows a comparison of the median oleosome size (0.25 wt % with respect to oleosome dry weight) and oleosome (0.25 wt % respected to oleosome dry weight)+alginate (0.67 wt %) at different pH values from 7.2 to 4.5, after heating at 85° C. for 30 min. FIG. 2B shows the same data as FIG. 2A but on a different scale excluding pH 4.5. FIG. 2C shows the median oleosome sizes (0.25 wt % with respect to oleosome dry weight) and oleosome (0.25 wt % respected to oleosome dry weight)+alginate (0.67 wt %) prepared at different pH values and heating at 85° C. for 30 min after 1 month storage at 4° C. FIG. 2D shows the same data as FIG. 2C but on a different scale excluding pH 4.5.

FIG. 3 is a photograph showing that a soybean oleosome fraction including or combined with alginate according to the present invention produces a stable emulsion in hot coffee that is not achieved without the alginate. Samples were added when the coffee was hot (˜75° C.).

FIG. 4A shows the dispersion stability of a soybean oleosome fraction with alginate at various ratios ranging from zero added alginate upwards, with the dispersion stability being indicated by zeta potential measurements. FIG. 4B shows the D50 sizes of oleosomes for the same admixtures. FIGS. 4C and 4D show the same data but excluding the data point with zero added alginate.

FIG. 5A. shows a comparison of oleosome and oleosome with added pectin at ratios of 10:1 and 1:3 at different pH values from 7.2 to 4.5, after heating at 85° C. for 30 min. Oleosome concentration was kept constant at 0.25 wt % (with respect to oleosome dry weight). FIG. 5B. shows the same data as FIG. 5A excluding oleosomes at pH 4.5. FIG. 5C shows a comparison of oleosome and oleosome added with gum Arabic at ratios of 10:1 and 1:3 at different pH values from 7.2 to 4.5, after heating at 85° C. for 30 min. Oleosome concentration was again kept constant at 0.25 wt % FIG. 5D shows the same data as FIG. 5C excluding oleosome at pH 4.5

FIG. 6 is a photograph that shows a from left to right, coffee (100 mL), coffee added with 9 mL oleosome (4.2 wt % with respect to oleosome dry weight), coffee added with 9 ml dispersion oleosome (4.2 wt %)+pectin (0.5 wt %), and coffee added with 9 mL dispersion oleosome (4.2 wt %)+gum Arabic (0.5 wt %). Samples were added in each instance when the coffee was hot (˜75° C.).

### DETAILED DESCRIPTION OF VARIOUS EMBODIMENTS AND EXAMPLES OF THE INVENTION

An oleosome is a naturally occurring oil globule particle suspended in an aqueous media and encapsulated by a phospholipid and protein. An oleosome fraction is an extract of a seed or other plant tissue that contains oleosomes and associated proteins. Examples of products that include oleosome fractions include the vegetable milks that are the subject of the present application, for example, milks and creams made from sunflower, almond, cashew, macadamia nuts, oats or rice as typically obtained by separation of a cream or butter layer from a plant extract containing oils mixed with water as by centrifugation to remove solid materials. In this regard, a vegetable milk in the milk classification typically contains 1 to 20% oils and a plant cream contains 20 to 95% oils by weight on a dry weight basis.

The present invention relates to the discovery that when an oleosome fraction is admixed with an anionic polysaccharide, the functionality of the oleosome fraction as a creamer is increased, especially making the creamer suitable for use in products that have a low pH (e.g, below pH 5.5) and for use in hot food and beverages like coffee or tea, where an ordinary oleosome fraction not admixed with the anionic saccharide would tend to separate and undesirably form a particulate colloid rather than the smooth emulsion that is desired.

Preparation and Stability Evaluation of Oleosome and Oleosome Admixed with Propylene Glycol Alginate at pH 4.5-7.2 and at 85° C.

An oleosome fraction as characterized in Table 1 below was prepared from soybeans according to the following protocol. Soybeans were soaked in water for 24-36 hours. Afterward, the beans were crushed using a blender with a 1:5-1:8 ratio of beans to water. Soy milk was obtained by separating the solid and liquid parts using a cheesecloth, followed by heating at 75-85° C. for 3-5 minutes to inactivate lipoxygenase. The liquid was centrifuged at 11,000×g for 30 minutes. The upper layer was recovered and distilled water was added to wash the oleosomes. The centrifugation was repeated and purified soybean oleosomes having a size of 0.4-0.5 μm (D50) were recovered. Table 1 shows the composition of this soybean oleosome fraction.

TABLE 1
Soybean oleosome composition.

| Composition | Dry weight (%) |
|---|---|
| Oil | 86.8 |
| Protein | 12.6 |
| Phosphorus | 0.21 |
| Total solids | 38 |

Physical stability studies were then done using an oleosome concentrate with and without the addition of propylene glycol alginate. An alginate solution (3 wt %) was added to the oleosome concentrate (for the with alginate sample) to achieve a final concentration of oleosomes at 0.25 wt % and alginate at 0.67 wt %. The dispersions were gently mixed using a propeller/stirrer, followed by pH adjustment to 7.2, 5.5, 5.0, and 4.5. The oleosome dispersions were each then heated at 85° C. for 30 minutes, followed by immediate immersion in cold water. The particle size of the oleosomes in each concentrate (with and without alginate) was measured using Partica LA-960 (Horiba, Kyoto, Japan).

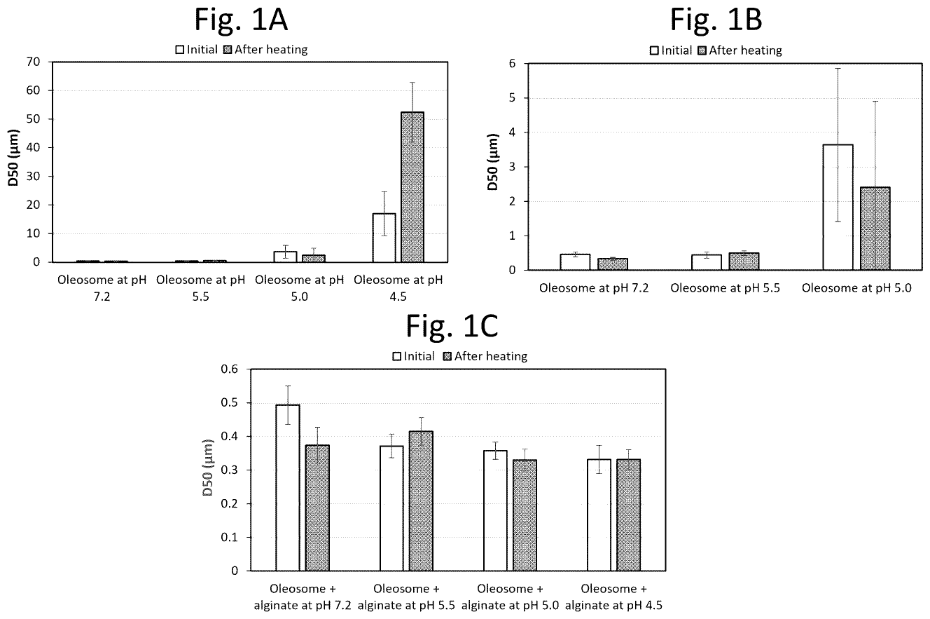

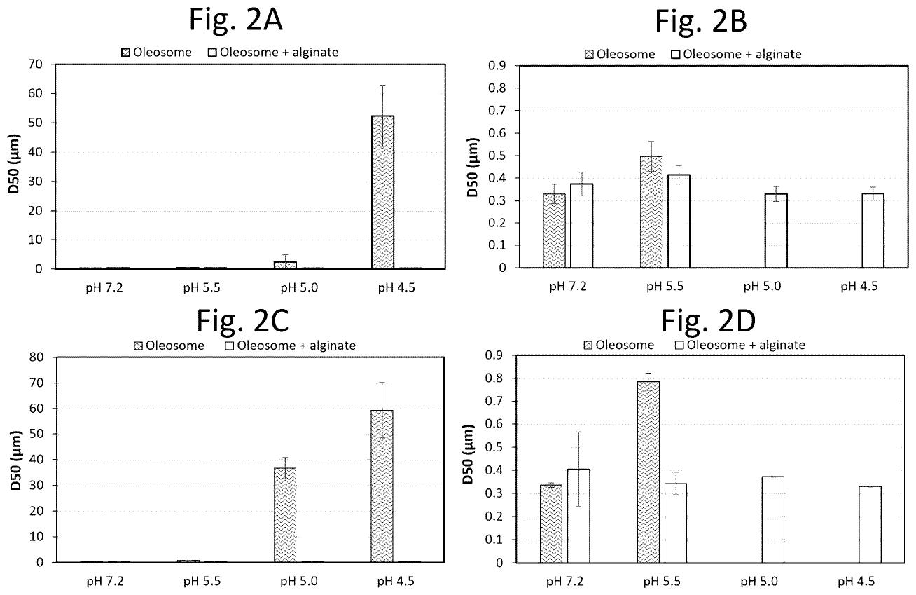

FIG. 1 and FIGS. 2A and 2B show the median size of oleosome samples at different pH values with and without additional alginate before and after heating, immediately after preparation of the with and without alginate concentrates. FIGS. 2C and 2D show the median size of oleosome samples at different pH values with and without additional alginate before and after heating, but after storage for 30 days at 4° C.

Inspection of the oleosome samples prepared as described above without alginate showed that at pH 4.5 the sample clearly had separated phases with fat globules rising to the top. Oleosomes without alginate had a larger median particle size (D50) of 2.40 and 52.38 μm at pH 5.0 and 4.5, respectively, while oleosomes admixed with alginate maintained its D50 of 0.32 and 0.33 μm at pH 5.0 and 4.5, respectively. The results show that oleosome alginate mixtures were stable for over a month as indicated by no remarkable changes in D50, while samples without alginate showed instability during storage as indicated by an increasing D50 droplet size. The results clearly demonstrate the stabilization of oleosomes by admixture with this anionic polysaccharide, particularly at low pH (e.g. 5.0 and 4.5) and even at high temperature (e.g., 85° C.).

### Stability Evaluation of Standard Oleosome Fraction and Inventive Oleosome Fractions Including Propylene Glycol Alginate in Brewed Coffee.

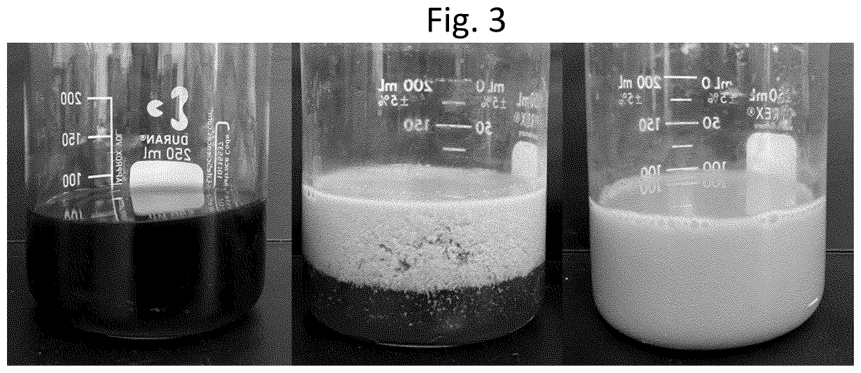

An equal volume of a stock solution of alginate (3%) was added to a volume of the oleosome fraction of Table 1 to achieve a final alginate concentration of 1.5 wt % and a final concentration of oleosomes of 12.7 wt % (with respect to oleosome fraction total dry weight). The samples were pasteurized at 85° C. for 15 min. There was no sign of particle aggregation or sedimentation after heating. Both samples were added to hot coffee (˜75° C.). FIG. 3 shows the visual appearance of the coffee with and without the addition of alginate, clearly showing the sample with alginate maintained its physical stability without any phase separation.

### Impact of Anionic Polysaccharide Concentration on Oleosome Stabilization

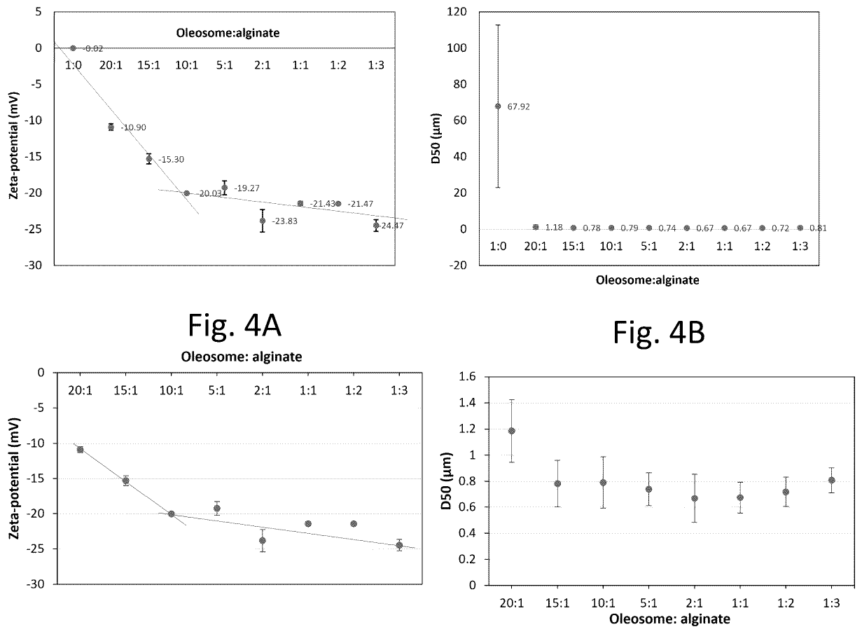

Portions of an soybean oleosome fraction prepared as described above and as characterized in Table 1 were mixed with portions of a stock alginate solution (3 wt %) to achieve inventive oleosome compositions at various mass ratios of oleosome: alginate of 20:1, 15:1, 10:1, 5:1, 2:1, 1:1, 1:2, 1:3. The pH of mixtures were adjusted to 4.5. The final oleosome concentration in the mixtures were kept constant at 0.25 wt %. The dispersion was gently mixed using a propeller/stirrer, followed by heating at 85° C. for 30 minutes and immediate immersion in cold water. The particle size of the oleosome samples were measured using a Zetasizer Nano (Malvern Panalytical, Malvern, UK) and Partica LA-960 (Horiba, Kyoto, Japan). FIG. 4A shows the increase of zeta-potential value as a function of increased alginate ratio which indicates the improved oleosome stability afforded by the alginate's addition. Zeta-potential is used to measure dispersion stability, where a value of ≥+/−20 mV indicates a stable dispersion (Samimi, S., Maghsoudnia, N., Eftekhari, R. B., & Dorkoosh, F. (2019). Lipid-based nanoparticles for drug delivery systems, Characterization and biology of nanomaterials for drug delivery, 47-76). FIG. 4B shows the D50 of the oleosomes in these oleosome: alginate mixtures at different ratios. At any ratio, the median dimension of oil droplets in the oleosome fraction with anionic polysaccharide is 0.2 to 2.0 microns, and in preferred embodiments is 0.25 to 1.0 microns.

Stable Oleosome Fractions Prepared with Pectin and Gum Arabic

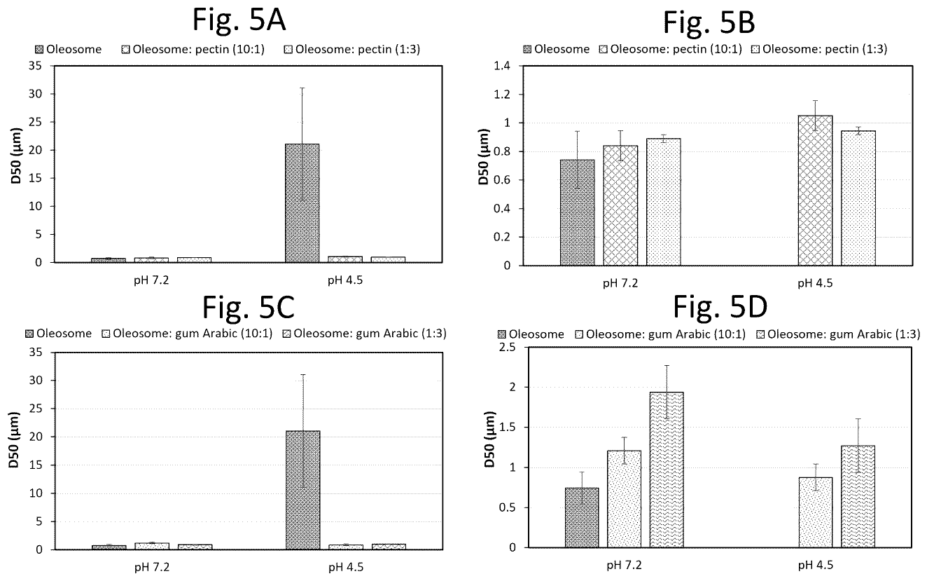

Pectin and gum Arabic solutions (3 wt %) were mixed with the soybean oleosome fraction made as described above and per Table 1 to achieve a couple of inventive compositions having different oleosome: anionic polysaccharide mass ratios (10:1 and 1:3) for each of the oleosome: pectin and oleosome: gum Arabic combinations. The oleosome concentration was kept constant in each at 0.25 wt %. These dispersions were gently mixed using a propeller/stirrer, followed by pH adjustment to 7.2 and 4.5. The inventive compositions thus prepared for evaluation were then each heated at 85° C. for 30 minutes, followed by immediate immersion in cold water. The particle size of each of the oleosome/pectin and oleosome/gum Arabic samples was then measured using a Partica LA-960 (Horiba, Kyoto, Japan). FIGS. 5A through 5D show that each of pectin and gum Arabic had the same effect as alginate in terms of stabilizing the D50 size of the oleosomes. In all cases the median size of the oleosomes at pH 4.5 is within 20% of the size of the oleosomes in a fraction not containing an anionic polysaccharide at pH 7.2

Stability Evaluation of a Standard Oleosome Fraction and the Inventive Oleosome Fractions with Pectin and Gum Arabic in Hot Brewed Coffee

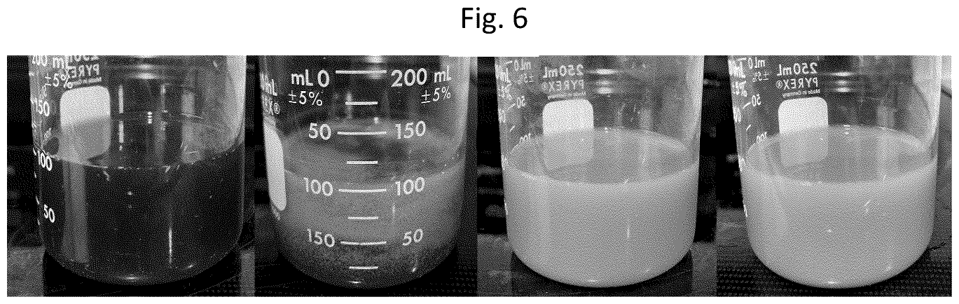

A stock solution of pectin or gum Arabic (3%) was added to the soybean oleosome fraction characterized as in Table 1 to achieve a 0.5 wt % final concentration of pectin or gum Arabic in the oleosome fraction. The oleosome concentration was 4.2 wt % (with respect to oleosome dry weight) after the addition of pectin or gum Arabic. The samples were again pasteurized at 85° C. for 15 minutes. There was no sign of particle aggregation or sedimentation after heating. Both samples were added to hot coffee (˜75° C.). FIG. 6 shows the visual appearance of the coffee with and without an unmodified oleosome fraction on the one hand and with and without an oleosome fraction including pectin or gum Arabic on the other, clearly showing the samples with pectin/gum Arabic maintained their physical stability without any phase separation.

### OTHER EMBODIMENTS

While the present invention has been exemplified above using an oleosome fraction prepared from soybeans, oleosome fractions prepared from other plant materials may be expected to exhibit the same beneficial effects. Examples of other oleosome fractions prepared from plant material that can be stabilized for heat and pH tolerance by combination with anionic polysaccharides include milks and creams prepared from, without limitation and by way of specific examples only, coconut, almond, cashew, macadamia, oat, rice, quinoa and hemp.

In addition, while the present invention has been specifically exemplified using propylene glycol alginate, pectin and gum Arabic, any other natural or synthetic anionic polysaccharides or any combination thereof may be used, as well. Examples of preferred anionic polysaccharides include alginate, pectin, gum Arabic, sulfated carrageenan, sulfated chondroitin, carboxymethyl cellulose and carboxy methyl starch.

The oleosome anionic polysaccharide mixtures of the present invention can be used to make a variety of non-dairy products through heating and acidification process where a cream like texture and creaminess taste are desired. Example products include creamy juices and soda beverages, coffee creamers, yogurt, milk, and ice cream. The invention is particularly useful for more acidic products having a pH below 5.5, like acidified milks, citrus juices, smoothies, sherbets and creams, as well as for products made for mixing with acidic beverages or hot beverages like coffee and tea.

1. A vegetable milk comprising an oleosome fraction and one or more anionic polysaccharides.

2. The vegetable milk of claim 1, wherein the ratio by weight of oleosomes to the one or more anionic polysaccharide is from 10:1 to 1:3.

3. The vegetable milk of claim 1, wherein the ratio by weight of the one or more anionic polysaccharides to oil in the oleosome fraction is from 1:10 to 3:1.

4. The vegetable milk of claim 1, wherein the one or more anionic polysaccharides are selected from the group consisting of alginate, pectin, gum Arabic, sulfated carrageenan, sulfated chondroitin, xanthan gum, carboxymethyl cellulose and carboxy methyl starch.

5. The vegetable milk of claim 4, wherein the one or more anionic polysaccharides include alginate.

6. The vegetable milk of claim 4, wherein the one or more anionic polysaccharides include gum Arabic.

7. The vegetable milk of claim 4, wherein the one or more anionic polysaccharides include pectin.

8. The vegetable milk of claim 1, wherein the vegetable milk is in the form of a cream prepared from soybeans.

9. The vegetable milk of claim 1, characterized in that when heated to a temperature of 85° C. for 30 minutes at a pH of 4.5 to 5.5, a median dimension of oil droplets in the oleosome fraction of the milk is within 20% of a median dimension of oil droplets in the same oleosome fraction as determined in the same manner but at pH 7.2.

10. The vegetable milk of claim 9, wherein a median dimension of the oil droplets in the oleosome fraction of the milk is 0.2 to 2 microns.

11. The vegetable milk of claim 10, wherein a median dimension of the oil droplets is 0.25 to 1 micron.

12. A food product for human consumption, comprising an oleosome fraction prepared from a plant material selected from the group consisting of soybeans, oat, rice, almond, cashew, macadamia or coconut and one or more anionic polysaccharides present in a sufficient proportion with respect to the oleosome fraction as to provide an oleosome fraction with improved resistance to agglomerating or separating out when the food product is heated or possesses an acidic pH.
